(19) United States
(12) Patent Application Publication
(10) Pub. No.: US 2006/0149889 A1
(43) Pub. Date: Jul. 6, 2006

(54) Method and system for backup data access through standard network file sharing protocols

(76) Inventor: Sridhar Sikha, San Jose, CA (US)

Correspondence Address: GEORGE M STERES, 20200 PIERCE RD, SARATOGA, CA, 95070, US

(21) Appl. No.: 10/360,260

(22) Filed: Feb. 5, 2003

(51) Int. Cl. G06F 12/14; G06F 7/00

(52) U.S. Cl. 711/100; 707/100

(57) ABSTRACT

Back-Up (B/U) data is made immediately available to users on a networked client-server system by standard file sharing protocol methods using the user accessible Back-Up and Restore (B/U/R) process of the present invention. Implementations of the invention first extract file data and file meta-data from user files during a B/U by a B/U application. The B/U/R invention process uses the extracted file data and file meta-data to build a B/U file structure containing the backed up user files on a B/U storage device. The B/U file structure is constructed so that it is responsive to File Sharing Protocols common to the clients (users) of the system. Thus, once a user's file is backed up by the B/U/R process of this invention, it is immediately accessible to the user from the B/U storage device in the event of client's data loss, corruption or a server system crash.

### BACKGROUND OF THE INVENTION

1. Field of Invention

The present invention relates to file backup, restore and data availability, and in particular to a method and apparatus for making available of backed up data through standard network file sharing protocols.

2. Prior Art

Non-Mainframe computing environment often refers to open systems, where client-server computing is prevalent. The executables (program code) for applications like database servers, E-Mail servers and the data generated by these applications as well as the data generated by the clients reside as data (files) on the computing servers. The client computer accesses these data from the server through file sharing protocols like NFS, CIFS.

Backup application software for a client server system runs on these servers and at scheduled intervals backs up the server's data (and sometimes the programs) according to a pre-determined client-server system B/U policy; e.g., full, incremental, differential, daily etc.) to backup media, which could be Tape, Optical, Disk or any other non-volatile persistent media. These backup applications also provide ability to restore all or selected data from a given backup set on a given server to the same or to a different server. A version of these backup applications may also run on the client computers, which provides a client the ability to search for a desired file from a B/U set and restore it, given proper authorization.

If the server data is corrupted for any reason, e.g., a hardware failure, power failure or inadvertent deletion by users, then the server's data is restored from the backup data set previously stored on the backup media. Depending on the amount of backup data required to restore a server, client users may experience several hours of non-availability of data. Also depending on the terms of any Service Level Agreements (SLA) in place, and how old the file is, the restoration delay of a particular file to a user could be from an hour to several hours or days. Some companies have tape libraries with several hundred slots of cartridges to keep huge amounts of data to meet the SLA.

The restore is typically done through the backup application provided by the backup vendor, which consults a backup data base called “catalog”, which contains the information about which tape cartridge has which file.

In the current state of practice, if a backup operation is in progress and a new restore request comes, then either the backup needs to be suspended, which typically increases the time of backup or a drive has to be dedicated for the restore purpose which increases the cost and reduces the utilization.

Also in the current state of practice, when multiple requests come for restore, they are done in sequence and there could be still further delay as files needed to be restored could be on different tapes and may need manual intervention.

With increased focus on restore, MIS departments are focusing on improving restore processes and maintaining high availability. Mirroring of data or replication is used as a means to achieve ServerA\availability, but on the down side if there is a corruption or a virus, this gets replicated too, rendering data useless in time of a restoration, forcing system administrators to try few older datasets to find a good data set which is not infected by virus. This trial and error could be time consuming.

The alternative is to do frequent full backups to meet the SLA for restore times. But this usually results in application servers being not available or at less than desirable levels. The other alternative is a weekly full backup followed by incremental and or differential backups but restoration time could be large if the number of incremental and/or differential tapes is large.

Currently in a Microsoft Exchange environment, backup at the message level rather than backup at the database level takes four times more delay and 4 times more storage space. Many companies do not use the message level backup due to the excessive backup delays and storage space. Therefore, when users make a request for message level restore either MIS has to go through a cumbersome and costly process of restoration or deny the user request for message level restore causing total non-availability of data.

Referring to FIG. 1, there is shown a schematic diagram 100 for data stored on a server 110. As is well known, user data are stored on servers 110 in an inverted tree-like structure of directories (folders) 112, sub-directories (sub-folders) 114, and files as user data files 120. The directories or folders 112 and subdirectories 114 are special type files that contain other directories and files. Traversing from the files 120 (the leaves of the tree structure) one traverses up the tree to the root (or root directory) 122, which is sometimes called a mount point, volume or a drive. Each drive or mount point is called a file-system.

Each file 120 includes (user) data 130 along with certain other file information about the owner (originator) of the file, file size, and other file attributes such as file access permissions, date/time when was the file last accessed/modified, permission level, archive status, encryption/compression status and other information like whether it is read-only, read-write etc. This other file information, which describes the file, is called meta-data 132. The files and directories are grouped under the mount points or volumes. The operating system that administers the transfer of data and arrangement of the volumes, directories and files also keeps track of additional information about the files, directories and volumes being administered: i.e., how much total space the file is allocated in the storage media comprising the volume 122, e.g., space on hard disk drive 140 attached to a server 110, and how much of the allocated space is occupied and how much remains free along with the file's meta-data 132. The terms data, meta-data, volumes are understood for people skilled in the art.

Referring to FIG. 2 and FIG. 3, there are shown examples of the B/U data structure for a typical prior art backup process 200 in a client-server VTS system environment 300. To backup a file 154 from one of the user files 120, a Backup software application 152 on the server 110 combines B/U application meta-data 158 with the file's user data 130 (the user's data contents), and the file's meta-data 132, and generates a B/U data structure (a file or B/U data set) 156. B/U meta-data 158 contains additional information specific to that B/U application for each file that is getting backed up.

Next, the application 152 transfers the B/U data set 156 (including file name, permissions, etc.) to a backup device 160 through a data connection 162. There are various formats of backup devices 160 known in the art, like DDS, DAT, DLT, LTO, AIT etc.

The B/U data set 156 is transferred to the B/U device 160, adding transfer protocol headers (not shown) according to the transfer protocol of the data connection 162.

The data connection 162 typically has a hardware component and a data transfer protocol. Typical data connection hardware includes, for example, IDE, SCSI, parallel SCSI, Fibre Channel, iSCSI, or NDMP. In a server environment, the predominant data transfer protocol for data storing and retrieving with data connection 162 is SCSI. The backup device 160 could be another disk drive, or could be a tape device accessible through data connection 162.

The backup device 160 receives the B/U data set 156 after transfer by data connection 162, strips the protocol headers and stores the B/U data set 156 on the backup's storage media 164 (e.g., magnetic tape). The backup device 160 may reformat the B/U data set 156 into a different format 166 in accordance with the device's format specification in order to store it in the device's own storage media locations (not shown).

In some prior art applications, the B/U device 160 may be a magnetic tape drive emulator for example that emulates a tape cartridge device. In these circumstances, the B/U data set 156 is formatted by the B/U device emulator 160 to appear to be stored on a physical tape device of a particular model in terms of capacity and tape format like DDS, DAT, AIT, LTO, S-DLT etc., so that the B/U data set 156 can be retrieved by software packages for that particular emulated B/U device 160. In FIG. 2, the dotted line 168 indicates the B/U device 160 is tape device emulator that writes the backup data set 156 as another file (not shown) stored in a tape storage format on the server's hard disk 140.

Referring again to FIG. 3, there is shown a schematic block diagram of Prior Art VTS client-server system 300 using the storage architecture and data structure of FIG. 1 and FIG. 2. The system 300 includes UserA (PC) system 302 and server 110, both connected to network 304 by network connections 306. User file 154′ is stored in server storage device (disk) location 312. The server 110 is connected by link 308 to a backup device 160 for storing user backup file (part of a B/U data set) 154 in the backup device format 166. In the Prior Art backup process of FIG. 1 and FIG. 2, the user system 302 has backup agent software 310 that communicates with Backup Software 152 on the Server 110, sending a list of files (e.g., 154′) to be backed up as part of a B/U data set based on predetermined backup policies. Usual backup policies include full backup, incremental or differential or a daily backup.

When UserA has to retrieve file 154′ from a B/U data set for any reason (because the file 154′ has been deleted, corrupted, or lost) the backup software agent 310 lists the files backed up with the B/U data set and the user selects the file 154′ to be retrieved, then the backup agent software 310 cooperates with the server backup application 152 communicating through the network 304 and network connections 306 according to their protocols. The server application 152 then communicates by link 308 to the backup device 160, through the server-B/U device protocols and drivers, accessing the B/U data set in backup media's stored data 166, which contains the user's backup file 154. The device 160 provides the backup data file 154 to the server which then restores the original data file 154′ to retrieval destination 312 specified by the server. The B/U application 152 then notifies the user system that the requested file 154′ has been restored and is available.

The B/U device 160 responds to read requests from the server by providing B/U data 154 from the B/U data set from the appropriate B/U media's stored location 166 through the intermediation of the data protocols of the B/U device 160 and link 308.

FIG. 4 depicts steps of typical prior art B/U process 200.

Step 210 is the transfer of data through a physical connection; i.e., a Hardware interface(s) like Fiber Channel, SCSI, IDE, iSCSI, FICON, ESCON and other technologies through which the data (e.g., B/U data set 154) to get backed up comes (e.g., connection 306) to module 220.

Step 220 represents software or a firmware driver(s), which manages step 2 1 0 and receives data from (transfers data to) 210. The data transferred is dependent on the driver's protocol, so it could be in the form of SCSI blocks or IDE or some other defined protocol. 220 strips the data transfer protocol headers (for example SCSI) and presents the resulting payload (the transferred data) to higher layers. Apart from receiving data, 220 can also transmit data provided by the higher layers. Module 220 also may participate in the management and initialization functions of the data transfer protocol e.g., SCSI protocol. Step 220 represents the firmware/software device driver processes managing the Interface Device Drivers in module 210 and to read and write data to/from 210 and to indicate/receive data to/from module 230.

Step 230 is the Tape file Format module: this module writes the data received from module 220 in a tape file format; either for an actual tape drive or for a tape drive emulator. This module writes the data sent to device driver module 220 in a tape file format.

If Step 230 emulates a tape cartridge (in the case of simulating tape B/U). Some of the functions of this module could be compression, tape format simulation, examples being DDS, DAT, AIT, LTO, S-DLT etc. 230 writes the data into a file on the hard disk, which simulates a tape. Also this module writes the label information provided by the backup software. This module also responds to read requests from the backup applications, such as during a file restore. Backup software (i.e., the B/U application) typically maintains a catalog of which files went into which tape cartridge, what is the label of the cartridge and the retention period of the cartridge. Step 230 saves and returns B/U data in the tape file format to/from the tape or tape emulator B/U device 160 of FIG. 3 in response to communication 162 from step 220. Step 260 of Virtual Tape Systems may provide monitoring and administration (e.g., SNMP) through network protocols (TCP/IP, IPX, others) 270 and network connection 275.

Such prior art B/U systems have a number of features that limit availability of backed up user data under certain conditions. For example:
With Multiple device and communication protocols users may need to learn new applications, methods and tools for different types of B/U devices.
Excessive delay in user's data availability may be caused by the non-availability of backup tapes if they are archived in a remote location, or system operators are unable to promptly respond to tape mount requests.
Published User data shared by more than one user cannot be accessed by other users on the system until an entire B/U operation is completed and all B/U files are restored, even if only one file is commonly used.
All users on the system 300 must have the same version of B/U agent software and be familiar with the B/U message syntax of the server application 152. Users that connect to different systems from time to time then have to have multiple versions of B/U agent applications to remain compatible with different server applications 152.
B/U files will not be available until various sets of backed up user data like multiple full, incremental and differential backups have been completely restored. This can be quite inconvenient when restoring a corrupted database or virus infected mail server.
To completely restore a system state one typically needs to do frequent backups, e.g., a full backup followed by incremental backups. No write operations can be performed until the restore is complete.
The B/U operation only creates one copy of the B/U on the B/U device at a single location unless another copy is independently made at another remote location.

There exists a need for method and apparatus to address the above deficiencies. The current invention addresses those.

### SUMMARY OF THE INVENTION

### Objects and Advantages

The present Back-Up and Restore (B/U/R) invention relates to a system and a method for making user backup data available through standard file sharing protocols like NFS, CIFS etc. The invention more specially relates to a system and method, which makes backed up user data from a first client system, readily available (with permission) to any other client for reading and writing simultaneously while the first client is being restored.

Since the backed up user data is available through file sharing protocols like CIFS and NFS, the end users can retrieve their lost user data themselves from steps well known in the art such as the more familiar “Network Neighborhood” present on the Microsoft Windows or through NFS mount points in a Unix environment, instead of proprietary applications provided by the backup software vendors, resulting in better productivity of end users and the MIS personnel. Persons skilled in art understand how to make available files on a server through the common file sharing protocols like CIFS and NFS.

The present (B/U/R) invention gives access to the backed up user data, simultaneously while backups are happening. In contrast, prior art B/U systems require that a user go through a process of requesting a B/U operation be performed by a server administrator, waiting until the necessary files are retrieved, possibly from a remote location, waiting still longer while tapes are mounted on tape spindles, and waiting still longer as the desired file is located by spooling sequentially through the tape. In a worse case scenario, there may be multiple tapes to be mounted and a limited number of tape spindles available, which stretches out the retrieval process even more.

This (B/U/R) invention gives multiple users simultaneous access to the backed up user data with out being limited by having the data distribute among many B/U tapes and having a limited number of tape spindles available. The present invention can provide nearly simultaneous data access to many users in parallel, limited only by the size of the disk array B/U data is stored on.

This invention provides simultaneous access to various sets of backed up user data like multiple full, incremental and differential backups. This is useful in restoring a corrupted database or virus infected mail server. The present Invention permits a system administrator to try backups in a descending order of time line till a good set of data is found.

This invention eliminates the need to do frequent full backups of server systems. One has the option to do only one full backup followed by incremental backups without substantial penalty in data availability. A complete server system state can be created from the one full backup data set and the full set of incremental B/U data sets by merging the full backup with the complete set of incremental backups on a B/U data store with simple symbolic links. Alternatively, the B/U data sets on the B/U data store may be combined by simply copying files from the full and incremental data sets, which reflects the sum of full and the incremental backups. The (B/U/R) invention, in one preferred embodiment, makes use of the existing operating system facilities of symbolic links to create a complete system state without duplicating the data from the B/U data sets.

The invention more specially relates to a system and method, which makes the B/U data files available from the B/U data store, through standard system file sharing protocols, for reading and writing simultaneously, while restore of B/U data to the system is taking place. This provides for zero-down time, and takes pressure of the MIS personnel during restores. Business continuance of today's IT infrastructure can benefit from this invention.

The present invention facilitates data availability for a server that is backed up by using available backup vendor applications through file sharing protocols like NFS and CIFS and through network protocols like TCP over networks like Ethernet.

### BRIEF DESCRIPTION OF THE DRAWINGS

FIG. 1 illustrates typical server storage architecture.

FIG. 2 shows data structure elements in typical prior art B/U-restore processes on systems configured with the architecture of FIG. 1.

FIG. 3 shows a schematic block diagram of a networked client-server system using the prior art storage architecture of FIG. 1 and B/U data structure/process of FIG. 2.

FIG. 4 is a flow chart of steps for a prior art B/U-restore method in the system of FIG. 3.

FIG. 5 is schematic block level diagram of the B/U-restore method and system of FIG. 4 with an embodiment of the present (B/U/R) invention added to improve restore data availability.

FIG. 6 shows a block diagram of a client-server system using a VTA embodying the present (B/U/R) invention.

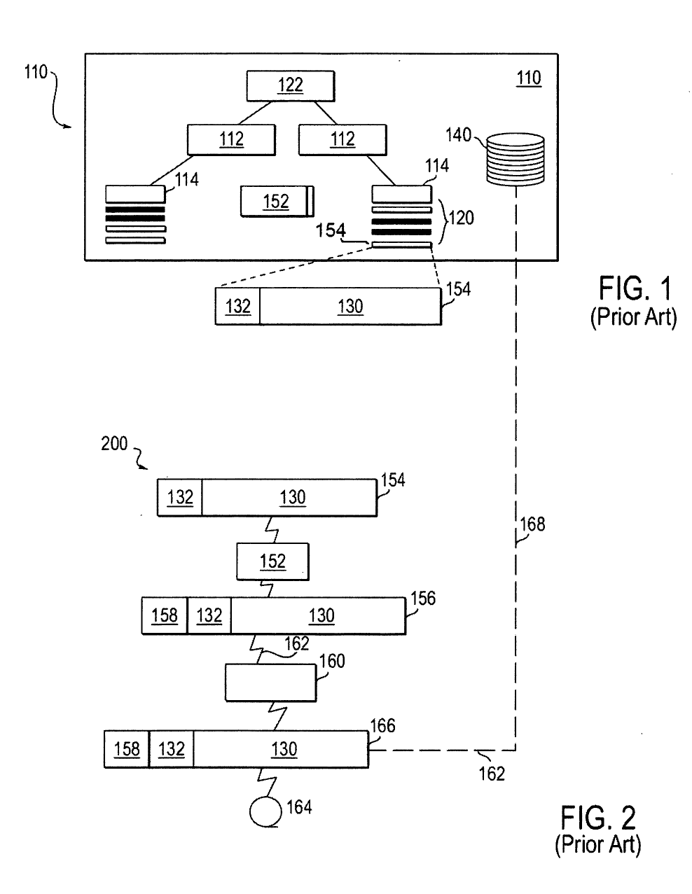

### DETAILED DESCRIPTION

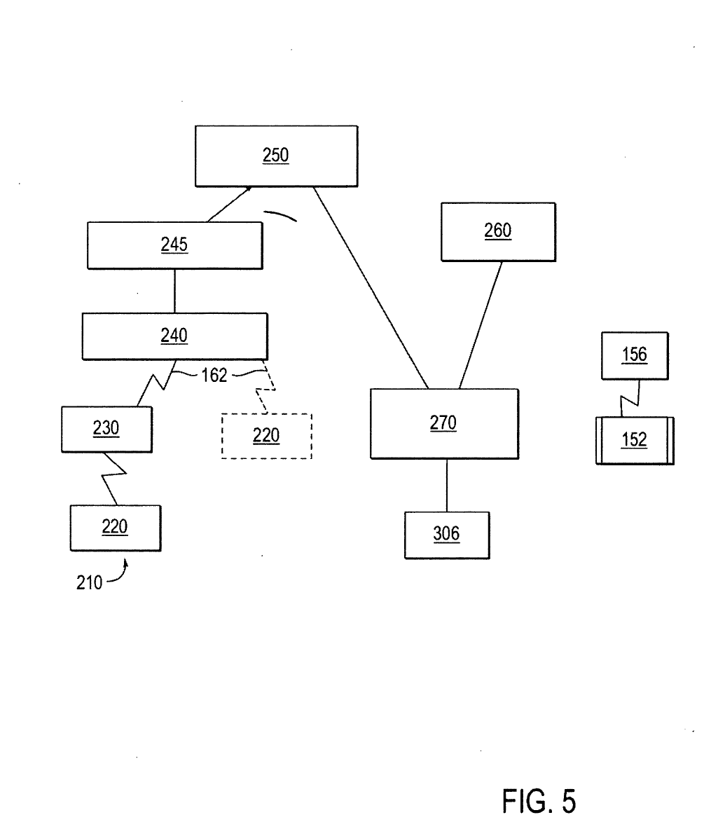

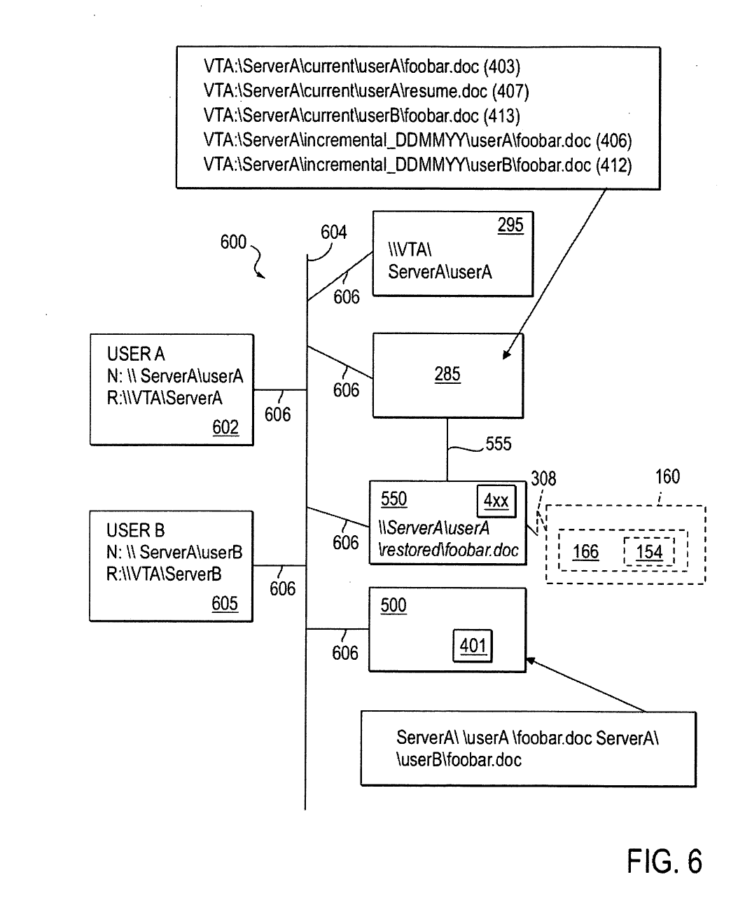

With regard to FIG. 5 and FIG. 6 there is shown a flow chart 500 of steps of the present invention implemented on a networked client-server system 600.

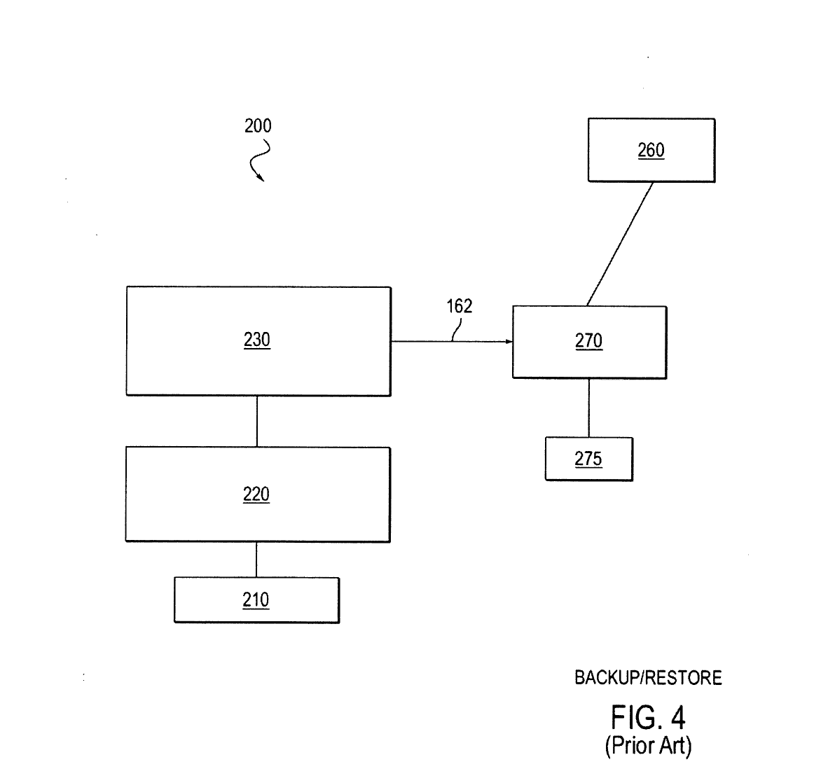

Step 220 (solid lines) again represents software or a firmware driver(s), which manages step 210 (FIG. 4) and receives data from (transfers data to) 210. The data transferred is dependent on the driver's protocol, so it could be in the form of SCSI blocks or IDE or some other defined protocol. 220 strips the data transfer protocol headers (for example SCSI) and presents the resulting payload (the transferred data) to higher layers. Apart from receiving data, 220 can also transmit data provided by the higher layers. Module 220 also may participate in the management and initialization functions of the data transfer protocol e.g., SCSI protocol. Step 220 represents the firmware/software device driver processes managing the Interface Device Drivers in module 210 and to read and write data to/from 210 and to indicate/receive data to/from module 240 (described below).

Step 230 is the Tape file Format module: this module writes the data received from module 220 in a tape file format; either for an actual tape drive or for a tape drive emulator. This module writes the data sent to device driver module 220 in a tape file format.

If Step 230 emulates a tape cartridge (in the case of simulating tape B/IU), some of the functions of this module could be compression, tape format simulation, examples being DDS, DAT, AIT, LTO, S-DLT etc. 230 writes the data into a file on the hard disk, which simulates a tape. Also this module writes the label information provided by the backup software. This module also responds to read requests from the backup applications, such as during a file restore. Backup software (i.e., the B/U application) typically maintains a catalog of which files went into which tape cartridge, what is the label of the cartridge and the retention period of the cartridge.

Step 240 is a step of Extraction of meta-data and data 130, 132 from the data protocol received, e.g., 154 or 156 (FIG. 2) or some other protocol for a particular system. Meta-data Extract module 240 does this, by getting data from module 220 or module 230. The data extraction step 240 is specific to the particular B/U data structure of the particular system and requires detail knowledge of that particular data structure, whether an open standard such as “MS tape format” or a proprietary structure.

Step 240 can be run in parallel to step 230 or can be run after complete backup is done. The choice depends on specific factors such as whether there is enough processing power; memory, disk space etc. present in a particular implementation. Selection of parallel or sequential operation can be made by persons familiar with system integration depending on system requirements and capability.

Step 245 is a File-Make Module that constructs a file-system on a backup disk (550) from extracted meta-data and data received from module 240. Module 245 populates the backup disk 550 with the backup directories and files. Alternatively 245 can just create directories and files with reparse points (Microsoft terminology for HSM support), so when a user or users wish to access data for a given file in the backup, it is read from the tape file format or from other archival means where the data is located. This mechanism is called HSM (Hierarchical Storage Management).

Step 250 is a data Exporting step. Data (tape format files and file systems, data base files) is exported using file-sharing protocols (like NFS, CIFS etc.) by module 250. This usually involves updating necessary data for example /etc/exports or sharing a directory in a Microsoft operating system with necessary permissions like read-only read-write etc.

Step 270 allows access by clients to such exported file systems through network protocols like TCP/IP, IPX in cooperation with network interfaces, e.g., network interface step 275.

### Operation of the Invention

With regard to FIG. 6 there is shown an example to illustrate benefits of the present invention. While we use Microsoft Windows running on a Intel CPU as an example, the same can be true on any other operating system which support file sharing protocols and network protocols like NFS, CIFS, TCP/IP, IPX etc.

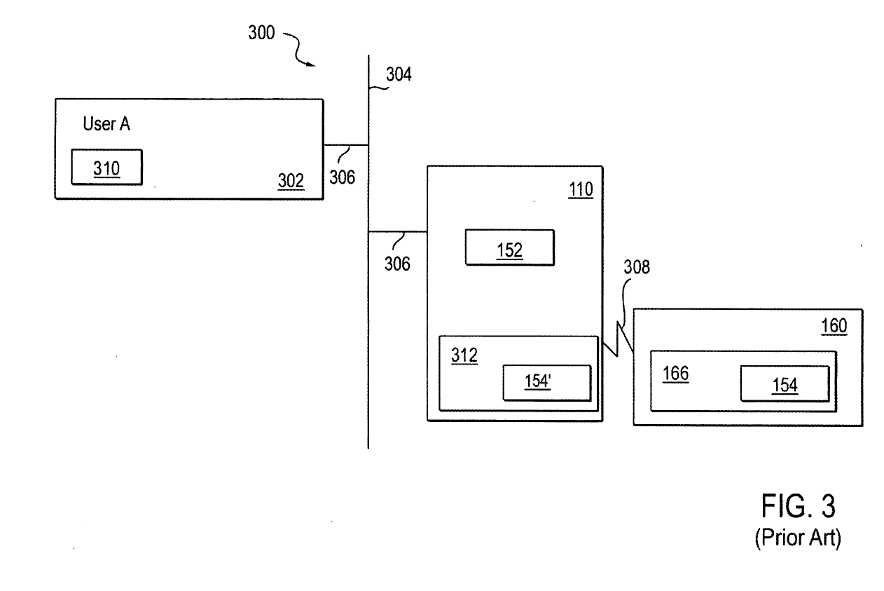

Referring to FIG. 6 there is shown a block diagram 600 of an embodiment of the present B/U data access invention implemented in a client-server system with a Virtual Tape Appliance (VTA) 285. The system 600 includes a user computer 602 running Microsoft Windows™ with necessary file sharing protocols on top of network protocols and network adapters (not shown) connected to a network 604. Network 604 additionally includes a file server “Server A” 500, a Backup server 550, and VTA “VTA Server” 285. The VTA 285 is connected to the Backup server 550 through a data connection 555, which could be a SCSI, Fibre Channel, iSCSI or any other data connection mechanism. All are connected to the network 604 through network adapters 606. Data connection 555 is preferably standard protocol connection such as 275 and 306 of FIG. 2 and FIG. 3.

The client computer 602 typically has a C:\drive which resides on a local hard disk (not shown). Through the standard protocols like NFS or CIFS, TCP/IP, in combination with a network card and with proper account name and authorization, users of the computer 602 can access files on the file server “Server A” 500; this is called mapping a network drive. In this case directory \\ServerA\UserA is mapped to client's N: drive in computer 602 e.g., as, N: \\ServerA\UserA. Such network mapping is usually done automatically through scripts (not shown) setup by the MIS.

In FIG. 6, N: is the network drive where the user saves the files like Microsoft EXCEL™ work books or Microsoft Word™ documents. The file servers 500 are computers to provide file access and they usually have multiple processors, huge memory, and large (disk drive) storage arrays attached. The environment we are describing is well understood for people skilled in the art.

Let us consider a scenario in which UserA of computer 602 saves a Word document called “foobar.doc” 401 to the network drive N:. another UserB during the same day also saves a document with the same name in a different computer, 605 assume the two documents are stored in ServerA 500 in file location 401 as the two files ServerA:\userA\foobar.doc and ServerA:\UserB\foobar.doc in further, let us assume that the files for both users were inadvertently deleted or inadvertently over written the next day. Fortunately the company does backup every night and backs up the two files ServerA:\userA\foobar.doc and ServerA:\UserB\foobar.doc in file 401 as B/U file 4xx in B/U server 550.

In prior art practice the user notifies the MIS to restore the file “foobar.doc” 401. Assuming the MIS is prompt, they would go to backup server 550, look at its catalog, which lists the file 401 as being backed up as 154 in B/U device (tape drive 160, dashed lines). MIS would then retrieve the backup file 401 to a temporary restore location 4xx, notify the user of the restored file's availability and location 4xx, for example on N:\restored\foobar.doc, which on the Server A 500 is mapped to \\ServerA\userA\restored\foobar.doc.

In FIG. 6 where the present invention is deployed, the MIS will enable the operation of the invention to map \\VTA\ServerA\UserA to R:, which points to VTA 285. e.g., modifies the login scripts, as is well known in the art, to map a network drive as R: \\ServerA\userA, which points to the VTA 285. When backup is done for the UserA data to the VTA, VTA saves the UserA backup data and creates the UserA files (403, 406, 407) on the VTA 285 hard disk and immediately makes the UserA data available through file sharing protocols (FSP) well known in the art. The FSPs enable the user to see and access the B/U files directly on the VTA disk rather than waiting for MIS to restore from tapes that may need to be retrieved from an off-site vault, mounted on tape drive 160 and restored by the B/U application in the manner of prior art.

In like manner, the UserB file ServerA:\UserB\foobar.doc is restored (not shown).

For example, after an incremental B/U by ServerA, the present invention method of FIG. 5 creates a file structure \\VTA\ServerA\user on the VTA 285 including the userA file: R:\incremental_DDMMYY\userA\foobar.doc (406).

where DDMMYY corresponds to date, month and year. In the case where the userA loses the foobar.doc all he/she has to do is go to R: and traverse down the directory tree to find the file in the incremental backup directory.

In an environment where the VTA is deployed, in the event of a ServerA system crash, the users have access immediately, through the FSPs to backed up ServerA files stored on the VTA after the ServerA crash, for both read and write purposes.

Let us consider the previous example where UserA 602 has network drive mapped to N: corresponding to ServerA:\userA. Let us assume userA needs access to foobar.doc but ServerA 500 has crashed and is under restoration from tapes (mounted on tape drivel 60, dashed lines) connected to backup server 550. While restore is happening, userA can already access foobar.doc by mapping VTA:\ServerA\current\userA to a network drive. The VTA 285 has the contents of the file foobar.doc from the latest backup; i.e., VTA:\ServerA\current\home\userA\foobar.doc. This can be done manually or automatically through scripts in a manner known to persons skilled in the art. Providing userA B/U file access to UserA 602, while file server 500 is being restored, reduces pressure on the MIS to meet strict SLAs and costs associated with it.

VTA 285 makes this possible by creating a current state of the file system of the file server ServerA 500 from the full B/U VTA:\ServerA\home\userA\foobar.doc and incremental backups, i.e., VTA:\ServerA\incremental_DDMMYY\home\userA\foobar.doc. This illustrated in the Text box 1 below and can be achieved by symbolic links or by data copy. People skilled in the art understand how to achieve this: e.g., by selecting a merge of latest files to create the

Text box 1
full B/U on day 1

\\VTA\ServerA\full

\userA
\foobar.doc
402

Incremental B/U on day 2:

\\VTA\ServerA \Incremental_DDMMYY \

| | |
|---|---|
| \userA | \userB |

| | |
|---|---|
| \resume.doc | \foobar.doc |

| | |
|---|---|
| 406 | 412 |

current B/U state recovered on day 2 by merge

| \\VTA\ ServerA\ current\ | |
|---|---|
| \userA | \userB |

\foobar.doc \resume.doc \foobar.doc

| | |
|---|---|
| 403 | 407 413 |

current state of the file system.

Implementation of the VTA embodiment 285 of the present invention in the system 600 makes it possible to have multiple users access B/U files to restore. Also it is possible to have the server user files backed up to VTA 285 while other B/U user files are being accessed for restore.

The VTA file systems thus created can be mirrored to another system over the network. 604. This is well understood by people skilled in the art and products exist which do file replication across systems over networks.

The tape files (i.e., on prior art system 160) thus created or the VTA B/U file systems thus created can be mirrored to a remote vaulting facility, where they are copied to tape cartridges matching the format and drives of the client location along with labels. This technology does not exist today, but the invention enables it.

An additional embodiment of the present invention is indicated by addition of a separate computer system 295 to the system 600. The invention steps (software modules) 245, 250, 270 that create and export the VTA disk files through file sharing protocols and TCP/IP are alternatively moved to the separate computer system 295. Module 240 and module 245 communicate with each other through network protocol stack. This is done for separating the tasks if not enough computing power resources are available without the addition of system 295, or for other reasons.

It should be understood that no limitation to the scope of the present invention is intended by examples shown here, and alterations and modifications in the illustrated diagrams and further applications of principles of invention as illustrated occur to one skilled in the art to which the invention applies.

1. In a server system having a server and at least one client system communicating over a network with said server, said server providing access to stored files managed by said server through file-sharing protocols, in which said network comprises a B/U application enabling creation of a B/U data set comprised of a selected set of files by transfer of file data and file meta-data of said selected set of files, a method of enabling recovery access to files consisting of an accessible copy of said selected set of files, comprising:
a. a step of extracting said file data and extracting said file meta-data from said transfer from said selected set of files;
b. a step of using said extracted file data and said extracted file meta-data to create said accessible copy of said selected set of files said accessible copy having a one-to-one correspondence with files of said B/U data set and configured to be accessible by said file-sharing protocols.

2. The method as set forth in claim 1 in which said file data-extraction step and said meta-data extraction step is done by said server during operation of said B/U application.

3. The method as set forth in claim 2 in which said recovery access to said accessible copy of said selected set of files is provided by said file-sharing protocols.

4. The method as set forth in claim 2 in which said recovery access to said copy of said selected set of files is provided to another client system communicating over said network with said server.

5. The method as set forth in claim 1 in which each copied file of said copy of said selected set of files created by said steps is accessible while said B/U application continues to transfer file data and file meta-data from other ones of said selected set of files.

6. The method as set forth in claim 1 in which said accessible copy is stored on a selected B/U storage device separate from a storage device used for storing said B/U data set.

7. The method as set forth in claim 6 in which said selected B/U storage device is selected from the group consisting of a mass storage device, a magnetic tape device, a magnetic hard disk, an opto-electronic hard disk, an opto-magnetic hard disk, and a Virtual Tape System.

8. The method as set forth in claim 1 in which said extracting of said file-data file meta-data and said creating of said accessible copy is in response to non-accessibility to one of said stored files on said server.

9. The method as set forth in claim 1 in which:
a. Said step of extracting said file data and extracting said file meta-data from said transfer from said selected set of files, and;
b. said step of using said extracted file data and said extracted file meta-data to create said accessible copy of said selected set of files is done by said server in response to a request to restore a selected one of said stored client files from said selected set of B/U files.

10. In a client-server network having a client-server and at least one client system communicating over a network with said client-server, said server providing access² to stored files managed by said client-server through file-sharing protocols, in which said network comprises a B/U application operating to transfer file data and file meta-data to create a B/U data set for a selected set of files by a file transfer protocol, a Back-up Data Access System comprising:
² Access: how does he define it and how does the industry define it? The text of the description includes reading, writing, copying, file data and file meta-data.
a. A data connection to said network;
b. A separate data connection to a separate file storage device;
c. Means for extracting said file data and means for extracting said file meta-data from said transfer;
Means for incorporating said file data and said file meta-data into a copy of said selected set of files on said separate file storage device through said data connection, said copy , each file of said copy having a one-to-one
correspondence with files of said selected set of files and configured to be accessible by said file sharing protocols.

11. The Back-up Data Access System as set forth in claim 10 in which said file data-extraction means and said meta-data extraction means is done by said server in response to a file access request for access to said B/U files in said B/U file structure from at least one client.

12. The Back-up Data Access System as set forth in claim 11 in which said access to said B/U files in said B/U file structure is provided to said at least one client.

13. The Back-up Data Access System as set forth in claim 11 in which said access to said B/U files in said B/U file structure is provided to another client system communicating over said network with said server.

14. The Back-up Data Access System as set forth in claim 10 in which said data extracting step is done while said B/U application continues to transfer file data and file meta-data from other stored client files.

15. The Back-up Data Access System as set forth in claim 10 in which said selected B/U storage device is separate from a storage device used for storing said B/U data set.

16. The Back-up Data Access System as set forth in claim 15 in which said selected B/U storage device is selected from the group consisting of a mass storage device, a magnetic tape device, a magnetic hard disk, an opto-electronic hard disk, an opto-magnetic hard disk, and a Virtual Tape System.

17. The Back-up Data Access System as set forth in claim 10 in which said extracting of said file-data file meta-data and said arranging of said B/U files in said B/U file structure is in response to non-availability of access to one of said stored client files on said server.

18. The Back-up Data Access System as set forth in claim 10 in which said extracting of said file-data file meta-data and said arranging of said B/U files in said B/U file structure is done by said server in response to a request from said user system to restore a selected one of said stored client files from said selected one of said B/U client files in said back up data set.

19. In a client-server network having a client-server and at least one client system communicating over a network with said client-server, said server providing client access³ to stored files managed by said client-server through file-sharing protocols, in which said network comprises a B/U application operating to transfer file data and file meta-data for a selected set of files by a file transfer protocol, and said selected set of files are used to create a B/U data set comprised of said selected set of files, a Back-up Data Access System comprising:
³ Access: how does he define it and how does the industry define it? The text of the description includes reading, writing, copying, file data and file meta-data.
a. A data connection to said network;
b. A separate data connection to a selected B/U storage device;
c. Means for extracting said file data and extracting said file meta-data from said transfer;
d. Means for incorporating said file data and said file meta-data into B/U files in a B/U file structure on said selected B/U storage device;
e. Means for arranging said B/U files in said B/U file structure so said B/U files have a one-to-one correspondence with files of said selected set of files and are configured to be accessible by said file sharing protocols.
Claim list

| Claim | Indep/dep | On claim | Type |
|---|---|---|---|
| 1 | I | — | M |
| 2 | D | 1 | M |
| 3 | D | 2 | M |
| 4 | D | 2 | M |
| 5 | D | 1 | M |
| 6 | D | 1 | M |
| 7 | D | 6 | M |
| 8 | D | 1 | M |
| 9 | D | 1 | M |
| 10 | I | — | S |
| 11 | D | 10 | S |
| 12 | D | 11 | S |
| 13 | D | 11 | S |
| 14 | D | 10 | S |
| 15 | D | 10 | S |
| 16 | D | 15 | S |
| 17 | D | 10 | S |
| 18 | D | 10 | S |
